(19) United States
(12) Patent Application Publication
(10) Pub. No.: US 2016/0175774 A1
(43) Pub. Date: Jun. 23, 2016

(54) PROCESS FOR ADSORBING HYDROGEN CHLORIDE FROM A REGENERATOR VENT GAS

(71) Applicant: UOP LLC, Des Plaines, IL (US)

(72) Inventors: Clayton C. Sadler, Arlington Heights, IL (US); David A. Wegerer, Lisle, IL (US)

(21) Appl. No.: 14/575,496

(22) Filed: Dec. 18, 2014

(51) Int. Cl. B01D 53/86; B01D 53/02

(52) U.S. Cl. CPC B01D 53/8659; B01D 53/02; B01D 2257/2045; B01D 2258/0283

(57) ABSTRACT

A process for adsorbing HCl from a regeneration vent gas. The regeneration vent gas from a regeneration zone is cooled, and the cooled regeneration vent gas is passed to an adsorption zone that is spaced apart from the regeneration zone. A spent catalyst is passed from a reaction zone to the adsorption zone. HCl from the regeneration vent gas is adsorbed onto the spent catalyst in the adsorption zone to enrich the spent catalyst with HCl to provide HCl-rich spent catalyst and deplete HCl from the regeneration vent gas to provide HCl-lean regeneration vent gas. The HCl-lean regeneration vent gas is purged to atmosphere, and the HCl-rich spent catalyst is passed to a regeneration zone disengaging hopper.

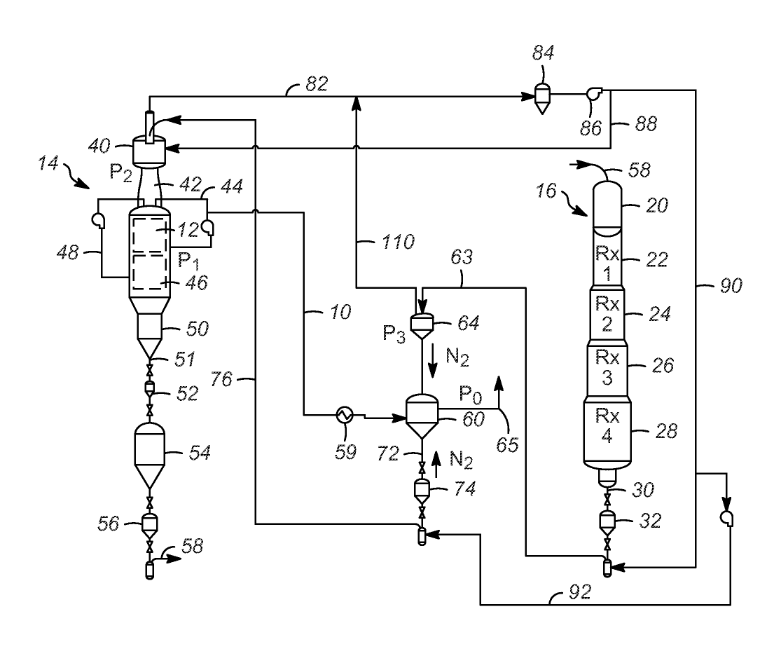

### FIELD OF THE INVENTION

This invention relates generally to processes for adsorbing hydrogen chloride (HCl) from a regeneration vent gas.

### BACKGROUND OF THE INVENTION

Numerous hydrocarbon conversion processes are widely used to alter the structure or properties of hydrocarbon streams. Such processes include isomerization from straight chain paraffinic or olefinic hydrocarbons to more highly branched hydrocarbons, dehydrogenation for producing olefinic or aromatic compounds, reforming to produce aromatics and motor fuels, alkylation to produce commodity chemicals and motor fuels, transalkylation, and others.

Many such processes use catalysts to promote hydrocarbon conversion reactions. These catalysts tend to deactivate for a variety of reasons, including the deposition of carbonaceous material or coke upon the catalyst, sintering or agglomeration or poisoning of catalytic metals on the catalyst, and/or loss of catalytic metal promoters such as halogens. Consequently, these catalysts are typically reactivated in a process called regeneration.

Reactivation can include, for example, removing coke from the catalyst by burning, redispersing catalytic metals such as platinum on the catalyst, oxidizing such catalytic metals, reducing such catalytic metals, replenishing catalytic promoters such as chloride on the catalyst, and drying the catalyst. For example, U.S. Pat. No. 6,153,091 discloses a method for regenerating spent catalyst.

In a some regeneration processes, a catalyst is passed from a hydrocarbon reaction zone (reaction zone) to a catalyst regeneration zone which may include a burn zone, a chlorination zone, a catalyst drying zone, and a catalyst cooling zone. The catalyst includes coke, which is burned off from the catalyst in the burn zone. A chloride, which is a catalytic promoter, is replaced on the catalyst in the chlorination zone. The catalyst is dried in the catalyst drying zone, and cooled in the catalyst cooling zone, and then returned to the reaction zone.

In the chlorination zone, a chlorine-containing species (chloro-species) typically is introduced to contact the catalyst and replenish the chloride. The chloro-species may be chemically or physically sorbed onto the catalyst as chloride or may remain dispersed in a stream that contacts the catalyst. However, the introduced chloro-species causes a flue gas stream vented from the regeneration zone, referred to herein as regeneration vent gas, to contain hydrogen chloride (HCl). Emissions of HCl in the regeneration vent gas pose environmental concerns if the regeneration vent gas is purged to atmosphere.

Vapor phase adsorbent processes for removing HCl, such as those described in U.S. Pat. No. 5,837,636, significantly reduce regeneration vent gas HCl emissions without the need for caustic scrubbing. An example HCl adsorption process cools the regeneration vent gas. The cooled regeneration vent gas is contacted with spent catalyst in an adsorption zone where HCl is adsorbed onto the catalyst. The vent gas product from the adsorption zone is depleted in HCl and vented to atmosphere or routed to further downstream processing.

This adsorption zone is conventionally integrated into an existing regeneration zone by retrofitting the adsorption zone into a disengaging hopper through which spent catalyst is introduced into the regeneration zone (typically a vessel). However, such retrofitting in certain cases can be difficult to implement to optimize the performance, operability, and/or maintainability of the adsorption process. Further, retrofitting typically requires significant modification or replacement of the disengaging hopper, which is performed during a unit shutdown, increasing costs.

Additionally, with a conventional retrofitted adsorption zone in a regeneration zone, regeneration gas flows upward in catalyst transfer pipes (CTPs) between the burn zone and the adsorption zone in the disengaging hopper. This regeneration gas contains water due to the catalyst regeneration reactions in lower zones. To prevent condensation in the CTPs, the CTPs must be traced and insulated. The CTPs are removed and tracing disconnected periodically to perform maintenance on the regeneration zone. The pipes must also be handled carefully to avoid damaging the tracing and insulation.

Therefore, there remains a need for effective and efficient processes for adsorbing HCl from a regeneration vent gas.

### SUMMARY OF THE INVENTION

The present invention is directed to providing effective and efficient processes for adsorbing HCl from a regeneration vent gas.

Accordingly, in one aspect of the present invention, the present invention provides a process for adsorbing HCl from a regeneration vent gas. The regeneration vent gas from a regeneration zone is cooled, and the cooled regeneration vent gas is passed to an adsorption zone that is spaced apart from the regeneration zone. A spent catalyst is passed from a reaction zone to the adsorption zone. HCl from the regeneration vent gas is adsorbed onto the spent catalyst in the adsorption zone to enrich the spent catalyst with HCl to provide HCl-rich spent catalyst and deplete HCl from the regeneration vent gas to provide HCl-lean regeneration vent gas. The HCl-lean regeneration vent gas is purged to atmosphere, and the HCl-rich spent catalyst is passed to a regeneration zone disengaging hopper.

According to an aspect of some embodiments, passing the spent catalyst comprises passing the spent catalyst to an adsorption zone disengaging hopper that is spaced apart from the regeneration zone, and delivering the spent catalyst from the adsorption zone disengaging hopper to the adsorption zone.

According to an aspect of some embodiments, the regeneration zone is disposed within a vessel, and the adsorption zone is spaced apart from the vessel.

According to an aspect of some embodiments, the regeneration vent gas is cooled to a temperature between 38 C-190 C (100 F-375 F).

According to an aspect of some embodiments, the regeneration zone is in communication with an input of the adsorption zone.

According to an aspect of some embodiments, the regeneration zone disengaging hopper is in communication with an output of the adsorption zone.

According to an aspect of some embodiments, a pressure within the regeneration zone is greater than a pressure of the adsorption zone.

According to an aspect of some embodiments, a pressure of the regeneration zone disengaging hopper is greater than a pressure within the regeneration zone.

According to an aspect of some embodiments, the process further comprises introducing a lift gas comprising nitrogen from an elutriation and lift gas system into the adsorption zone.

According to an aspect of some embodiments, passing the spent catalyst comprises passing the spent catalyst to an adsorption zone disengaging hopper that is spaced apart from the regeneration zone, and delivering the spent catalyst from the adsorption zone disengaging hopper to the adsorption zone; and the process further comprises venting gas from the adsorption zone disengaging hopper into the elutriation and lift gas system.

According to an aspect of some embodiments, the HCl-rich spent catalyst is passed to the regeneration zone disengaging hopper via a lock hopper.

Another aspect of the invention provides a process for adsorbing hydrogen chloride (HCl) from a regeneration vent gas. The regeneration vent gas from a regeneration zone disposed within a vessel is cooled, and the cooled regeneration vent gas is passed to an adsorption zone that is spaced apart from the vessel. Spent catalyst is passed from a reaction zone into the adsorption zone. HCl from the regeneration vent gas is adsorbed onto the spent catalyst in the adsorption zone to enrich the catalyst with HCl to provide an HCl-rich spent catalyst and deplete HCl from the regeneration vent gas to provide an HCl-lean regeneration vent gas. A lift gas comprising nitrogen is introduced from an elutriation and lift gas system into the adsorption zone. A vent gas including a portion of the lift gas from the adsorption zone is returned to the elutriation and lift gas system. The HCl-lean regeneration vent gas is vented to atmosphere. The HCl-rich spent catalyst is passed to a regeneration zone disengaging hopper.

According to an aspect of some embodiments, a pressure in the regeneration zone disengaging hopper is greater than a pressure within the adsorption zone.

According to an aspect of some embodiments, a pressure in the regeneration zone disengaging hopper is greater than a pressure within a burn zone of the regeneration zone, and a pressure within the burn zone is greater than a pressure of the adsorption zone.

According to an aspect of some embodiments, the regeneration zone disengaging hopper is in communication with an output of the adsorption zone.

According to an aspect of some embodiments, the burn zone is in communication with an input of the adsorption zone.

According to an aspect of some embodiments, the adsorption zone comprises at least one module that is spaced apart from the vessel.

According to an aspect of some embodiments, the adsorption zone is an axial gas flow zone. According to an aspect of other embodiments, gas in the adsorption zone flows in a radial direction.

Another aspect of the invention provides a process for adsorbing HCl from a regeneration vent gas. The regeneration vent gas from a burn zone of a regeneration zone is cooled to a temperature of between 38 C-190 C. The regeneration zone is disposed within a vessel. The cooled regeneration vent gas is passed to an adsorption zone comprising one or more modules that are spaced apart from the vessel, wherein the burn zone is in communication with the adsorption zone. A spent catalyst and a lift gas containing nitrogen are introduced to the adsorption zone. HCl from the regeneration vent gas is adsorbed onto the spent catalyst in the adsorption zone, said adsorbing enriching the catalyst with HCl to provide an HCl-rich spent catalyst and depleting HCl from the regeneration vent gas to provide an HCl-lean regeneration vent gas. The HCl-lean regeneration vent gas is purged to atmosphere. The HCl-rich spent catalyst is passed from an output of the adsorption zone to a regeneration zone disengaging hopper that is in communication with an output of the adsorption zone. A pressure within the disengaging hopper is greater than a pressure within the burn zone, and the pressure within the burn zone is greater than a pressure within the adsorption zone.

In yet another aspect of the present invention, a process includes at least two, at least three, or all of the above described aspects of the present invention.

Additional objects, embodiments, and details of the invention are set forth in the following detailed description of the invention.

### BRIEF DESCRIPTION OF THE DRAWING

The drawing is a simplified process flow diagram in which:

The FIGURE shows a process for adsorbing hydrogen chloride (HCl) from a regeneration vent gas.

### DETAILED DESCRIPTION OF THE INVENTION

Referring to the drawings, the FIGURE shows an example process for adsorbing hydrogen chloride (HCl) from a regeneration vent gas. A regeneration vent gas line 10 outputs regeneration vent gas from a burn zone 12 of a regeneration zone 14. The regeneration zone 14 may be, for instance, disposed in a vessel or regeneration tower. The regeneration zone 14 is used to regenerate spent catalyst from a hydrocarbon reaction zone 16. Example hydrocarbon reaction processes include reforming, isomerization, dehydrogenation, and transalkylation. The example hydrocarbon reaction zone 16 is configured for a catalytic reforming reaction, and includes a reduction zone 20 and zones for first 22, second 24, third 26, and fourth 28 reactions, as will be appreciated by those of ordinary skill in the art. In one or more of the reaction zones 22, 24, 26, 28, catalyst deactivates and becomes spent. Spent catalyst is output via a spent catalyst output line 30 through an (optional) lock hopper 32.

For example, a catalytic reforming reaction is normally effected in the presence of catalyst particles comprised of one or more Group VIII noble metals (e.g., platinum, iridium, rhodium, palladium) and a halogen combined with a porous carrier, such as a refractory inorganic oxide. The halogen is normally chloride. Alumina is a commonly used carrier. The preferred alumina materials are known as the gamma, eta and theta alumina with gamma and eta alumina giving the best results.

A significant property related to the performance of the catalyst is the surface area of the carrier. Catalyst particles are usually spheroidal, having a diameter of from about 1/16th to about ⅛th inch (1.5-3.1 mm), though they may be as large as ¼th inch (6.35 mm).

During the course of a reforming reaction or other hydrocarbon process reactions, catalyst particles become deactivated as a result of mechanisms such as the deposition of coke on the particles; that is, after a period of time in use, the ability of catalyst particles to promote reforming reactions decreases to the point that the catalyst is no longer useful. This catalyst, referred to herein as spent catalyst, must be regenerated before it can be reused in a reforming process.

Accordingly, a spent catalyst having coke is passed from the hydrocarbon reaction zone 16 to the regeneration zone 14. The regeneration zone 14 includes a regeneration zone disengaging hopper 40, which delivers catalyst to the burn zone 12 through one or more conduits such as catalyst transfer pipes (CTPs) 42, preferably by gravity. The burn zone 12 comprises a portion of the regeneration zone 14 in which coke combustion takes place. Coke which has accumulated on surfaces of the catalyst because of the hydrocarbon reactions can be removed by combustion. Coke is comprised primarily of carbon but is also comprised of a relatively small quantity of hydrogen, generally from 0.5 to 10 wt-% of the coke. The mechanism of coke removal includes oxidation to carbon monoxide, carbon dioxide, and water. The coke content of spent catalyst may be as much as 20% by weight of the catalyst weight, but 5-7% is a more typical amount. Coke is usually oxidized at temperatures approximately in the range of 400° C. to 700° C. A circulating burn zone gas line 44 is provided for circulating gas from the burn zone 12. This circulated burn zone gas can be temperature controlled and supplemented with oxygen, if needed.

As a result of the high temperature, catalyst chloride is quite readily removed from the catalyst during coke combustion. A chlorination zone 46, which may be the same zone as the burn zone 12 or a separate, lower, zone, can receive a chloro-species input via a chloro-species input line (not shown) to replenish chloride that is not recovered. For the example process shown in the FIGURE, the chlorination zone 46 is separate from the burn zone 12. A circulating chlorination zone gas line 48 circulates chlorination zone gas, and the circulating burn zone gas line 44 circulates burn zone gas. The regeneration vent gas 10 from the regeneration zone 14, e.g., the gas from the burn zone 12, and in a particular example the gas that is circulated through the circulating burn zone gas line 44, contains HCl.

In the chlorination zone 46, the catalyst metal can be dispersed. The dispersion typically involves chlorine or another chloro-species that can be converted in the regeneration zone to chlorine. The chlorine or chloro-species is generally introduced in a small stream of carrier gas that is added to the chlorination zone. Although the actual mechanism by which chlorine disperses catalyst metal is the subject of a variety of theories, it is generally recognized that the metal may be dispersed without increasing the catalyst chloride content. In other words, although the presence of chlorine is a requirement for metal dispersion to occur, once the metal has been dispersed it is not necessary that the catalyst chloride content be maintained above that of the catalyst prior to dispersion. Thus, the agglomerated metals on catalyst can be dispersed without a net increase in the overall chloride content of the catalyst. Notwithstanding same, in the chlorination zone the gas may also replace chloride on the catalyst.

The regenerated catalyst from the chlorination zone 46 is dried in a drying zone 50 to remove water. The dried catalyst, which may be cooled, passes (e.g., by gravity) via a dried catalyst output line 51 through a flow control hopper 52, a surge hopper 54, and a lock hopper 56, before being passed to the reduction zone 20 in the hydrocarbon reaction zone 16 via conduit 58 and then reused in hydrocarbon reaction processes.

In an example process, to adsorb HCl from the regeneration vent gas, e.g., from the regeneration vent gas line 10, the regeneration vent gas is cooled, e.g., in a cooler 59, from a temperature of 482 C-593 C (900 F-1100 F) to a temperature of about 38 C-190 C (100 F-375 F). The cooled regeneration vent gas is passed from the regeneration zone 14, e.g., from the burn zone 12 or the chlorination zone 46, and in a particular example from the circulating burn zone gas line 44, to an adsorption zone 60 that is spaced apart from the regeneration zone 14. By “spaced apart,” it is intended that the adsorption zone 60 be separated from the regeneration zone by a distance, except for connecting lines such as the regeneration vent gas line 10 or other lines.

In an example process, the regeneration zone 14 is disposed within a vessel, and the adsorption zone 60 is disposed within a vessel that is spaced apart from the vessel of the regeneration zone. The adsorption zone 60 can be, for example, a separate module or stack of modules that are shop fabricated. This allows improved quality control, and reduces or eliminates modification to existing equipment such as the regeneration zone 14 when integrating the adsorbent zone 60 into an overall system by retrofitting.

In the adsorption zone 60, HCl from the regeneration vent gas is adsorbed onto spent catalyst in a vapor phase adsorption to provide HCl-rich spent catalyst, and deplete HCl from the regeneration vent gas to provide HCl-lean regeneration vent gas. The spent catalyst can be supplied from the hydrocarbon reaction zone 16, via spent catalyst input line 63, to an adsorption zone disengaging hopper 64. The adsorption zone disengaging hopper 64 preferably is disposed above the adsorption zone 60, so that spent catalyst passes from the adsorption zone disengaging hopper 64 to the adsorption zone by gravity.

The HCl-lean regeneration vent gas is purged as an effluent gas, e.g., by venting the gas to atmosphere via purge line 65. The HCl-rich spent catalyst exits the adsorption zone 60 via a catalyst output line 72 and a lock hopper 74, and is passed to the regeneration disengaging hopper 40 of the regeneration zone 14 via a catalyst input line 76 for catalyst regeneration.

In the process shown in the FIGURE, the adsorption zone 60 is embodied in one or more cylindrical volumes of catalyst so that gas in the adsorption zone flows in an axial direction. For example, cylindrical baffles can be provided to provide spaces for gas to enter and distribute around the adsorption zone 60. The height of the cylindrical volumes can be selected, for instance, to provide desired mass transfer, and to distribute the gas throughout the cylindrical volume.

In an alternative process, in the adsorption zone 60, gas flows in the radial direction, and spent catalyst flows in the axial direction. This arrangement allows much lower bed depths, thereby reducing bed pressure drop and the catalyst volume requirements in the adsorption zone 60. However, an example cylindrical arrangement, being counter-current, may be preferred over a cross flow arrangement such as a radial flow configuration for efficiency in overall mass transfer.

A lift gas (process gas) including nitrogen can be introduced to the adsorption zone 60 from a circulating elutriation and lift gas system. An example elutriation and lift gas system includes a gas output line 82 from the regeneration zone 14, for example from the regeneration zone disengaging hopper 40, where solid catalyst from the catalyst input line 76 is separated from lift gas in the regeneration zone. A dust collector 84 collects dust (e.g., catalyst particles) from the gas output line 82. An elutriation and lift gas blower 86 in the example elutriation and lift gas system supplies elutriation gas to the regeneration zone disengaging hopper 40 via circulating elutriation gas line 88, to the reaction zone 16 via reaction zone lift gas input line 90, and to the adsorption zone 60, via a lift gas input line 92. A spent catalyst lift system is provided via spent catalyst input line 63. An adsorption zone outlet lift system is provided via catalyst input line 76. Vent gas from the adsorption zone disengaging hopper 64 above the adsorption zone 60 is passed to the elutriation and lift gas system via vent gas line 110.

A portion of the lift gas from the reaction zone lift gas input line 90 and from the spent catalyst input line 63 provides a nitrogen flow to help seal the adsorption zone 60. As explained above, in conventional retrofit adsorption zones, regeneration gas flows upward in the CTPs, e.g., along CTP 42, from the regeneration zone 14 to the regeneration zone disengaging hopper 40. To prevent condensation in these lines, the CTPs typically are heat traced and insulated. CTPs are removed and tracing disconnected periodically to perform maintenance. The CTPs must also be handled carefully to avoid damaging the tracing and insulation.

In the process shown in the FIGURE, the adsorption zone 60 is in communication with an output of the regeneration zone 14, e.g., regeneration vent gas line 10, and the output of the adsorption zone, e.g., catalyst output line 72, is in communication with the regeneration zone disengaging hopper 40 and the elutriation and lift gas system. Further, the regeneration zone 14, e.g., within the burn zone 12 and at burn zone vent gas output line 44, is at a higher pressure than the adsorption zone 60, and the regeneration zone disengaging hopper 40 and elutriation and lift gas system is at a higher pressure than the output of the adsorption zone. For example, for a pressure P₁ within the burn zone 12, regeneration zone disengaging hopper 40 pressure P₂, adsorption zone disengaging hopper 64 pressure P₃, and a pressure P₀ at atmosphere at line 65 (e.g., for an atmospheric application), P₂>P₁, and P₃>P₀.

This example arrangement and pressure profile allows an example process to “seal” wet gas in the adsorption zone 60 and burn zone 12, with the use of a catalyst conduit such as catalyst transfer pipes (CTPs). CTPs enable movement of the catalyst between the zones contained in regeneration zone 14 and adsorption zone 60 while restricting gas flow. Gas flow and catalyst flow can be co-current or countercurrent within the CTPs. Wet gas can be prevented from entering the elutriation and lift gas system with a minimal amount of seal gas flow into the adsorption zone 60.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for adsorbing hydrogen chloride (HCl) from a regeneration vent gas, the process comprising:
cooling the regeneration vent gas from a regeneration zone;
passing the cooled regeneration vent gas to an adsorption zone that is spaced apart from the regeneration zone;
passing a spent catalyst from a reaction zone to the adsorption zone;
adsorbing HCl from the regeneration vent gas onto the spent catalyst in the adsorption zone to enrich the spent catalyst with HCl to provide HCl-rich spent catalyst and deplete HCl from the regeneration vent gas to provide HCl-lean regeneration vent gas;
purging the HCl-lean regeneration vent gas to atmosphere; and
passing the HCl-rich spent catalyst to a regeneration zone disengaging hopper of the regeneration zone.

2. The process of claim 1, wherein said passing the spent catalyst comprises:
passing the spent catalyst to an adsorption zone disengaging hopper that is spaced apart from the regeneration zone; and
delivering the spent catalyst from the adsorption zone disengaging hopper to the adsorption zone.

3. The process of claim 1, wherein the regeneration zone is disposed within a vessel; and
wherein the adsorption zone is spaced apart from the vessel.

4. The process of claim 1, wherein the regeneration vent gas is cooled to a temperature between about 38 C-190 C (100-375 F).

5. The process of claim 1, wherein the regeneration zone is in communication with an input of the adsorption zone.

6. The process of claim 5, wherein the regeneration zone disengaging hopper is in communication with an output of the adsorption zone.

7. The process of claim 6, wherein a pressure within the regeneration zone is greater than a pressure of the adsorption zone.

8. The process of claim 7, wherein a pressure of the regeneration zone disengaging hopper is greater than a pressure within the regeneration zone.

9. The process of claim 1, further comprising:
introducing a lift gas comprising nitrogen from an elutriation and lift gas system into the adsorption zone.

10. The process of claim 9, wherein said passing the spent catalyst comprises:
passing the spent catalyst to an adsorption zone disengaging hopper that is spaced apart from the regeneration zone; and
delivering the spent catalyst from the adsorption zone disengaging hopper to the adsorption zone;
further comprising:
venting gas from the adsorption zone disengaging hopper into the elutriation and lift gas system.

11. The process of claim 1, wherein the HCl-rich spent catalyst is passed to the regeneration zone disengaging hopper via a lock hopper.

12. A process for adsorbing hydrogen chloride (HCl) from a regeneration vent gas, the process comprising:
cooling the regeneration vent gas from a regeneration zone disposed within a vessel;
passing the cooled regeneration vent gas to an adsorption zone that is spaced apart from the vessel;
passing spent catalyst from a reaction zone into the adsorption zone;
adsorbing HCl from the regeneration vent gas onto the spent catalyst in the adsorption zone to enrich the catalyst with HCl to provide an HCl-rich spent catalyst and deplete HCl from the regeneration vent gas to provide an HCl-lean regeneration vent gas;
introducing a lift gas from an elutriation and lift gas system into the adsorption zone;
returning a vent gas including a portion of the lift gas from the adsorption zone to the elutriation and lift gas system;
purging the HCl-lean regeneration vent gas to atmosphere; and
passing the HCl-rich spent catalyst to a regeneration zone disengaging hopper.

13. The process of claim 12, wherein a pressure in the regeneration zone disengaging hopper is greater than a pressure within the adsorption zone.

14. The process of claim 12, wherein a pressure in the regeneration zone disengaging hopper is greater than a pressure within a burn zone of the regeneration zone; and
wherein a pressure within the burn zone is greater than a pressure of the adsorption zone.

15. The process of claim 14, wherein the regeneration zone disengaging hopper is in communication with an output of the adsorption zone.

16. The process of claim 15, wherein the burn zone is in communication with an input of the adsorption zone.

17. The process of claim 12, wherein the adsorption zone comprises at least one module that is spaced apart from the vessel.

18. The process of claim 12, wherein the adsorption zone is an axial gas flow zone.

19. The process of claim 12, wherein gas in the adsorption zone flows in a radial direction.

20. A process for adsorbing HCl from a regeneration vent gas, the process comprising:
cooling the regeneration vent gas from a burn zone of a regeneration zone to a temperature of between 38 C-190 C (100 F-375 F), the regeneration zone being disposed within a vessel;
passing the cooled regeneration vent gas to an adsorption zone comprising one or more modules that are spaced apart from the vessel, wherein the burn zone is in communication with the adsorption zone;
introducing a spent catalyst and a lift gas containing nitrogen to the adsorption zone;
adsorbing HCl from the regeneration vent gas onto the spent catalyst in the adsorption zone, said adsorbing enriching the catalyst with HCl to provide an HCl-rich spent catalyst and depleting HCl from the regeneration vent gas to provide an HCl-lean regeneration vent gas;
purging the HCl-lean regeneration vent gas to atmosphere; and
passing the HCl-rich spent catalyst from an output of the adsorption zone to a regeneration zone disengaging hopper that is in communication with an output of the adsorption zone;
wherein a pressure within the regeneration zone disengaging hopper is greater than a pressure within the burn zone; and
wherein the pressure within the burn zone is greater than a pressure within the adsorption zone.
